(19) United States
(12) Patent Application Publication
(10) Pub. No.: US 2019/0075340 A1
(43) Pub. Date: Mar. 7, 2019

(54) SYSTEMS AND METHODS FOR CONTENT DELIVERY

(71) Applicant: Christophe Michel Pierre Hochart, Hong Kong (HK)

(72) Inventor: Christophe Michel Pierre Hochart, Hong Kong (HK)

(21) Appl. No.: 16/120,767

(22) Filed: Sep. 4, 2018

Related U.S. Application Data
(60) Provisional application No. 62/553,694, filed on Sep. 1, 2017.

(51) Int. Cl. H04N 21/234; H04N 21/488; H04N 21/258; H04N 21/262; H04L 12/58; H04N 21/8545

(52) U.S. Cl. CPC H04N 21/23424; H04N 21/4882; H04N 21/25816; G06Q 50/01; H04L 51/02; H04N 21/8545; H04N 21/26241

(57) ABSTRACT

A method including: outputting for display, through a streaming application on a user device, a current video; overlaying an interactive link on a portion of the current video; receiving a user selection of the interactive link; and in response to receiving the user selection, deemphasizing the current video and displaying an advertising video corresponding to the selected interactive link.

### CROSS-REFERENCE TO RELATED APPLICATION

This Application claims priority under 35 U.S.C. § 119(e) to U.S. Provisional Patent Application No. 62/553,694, filed Sep. 1, 2017, the contents of which is hereby incorporated in its entirety as if fully set forth herein. This application is also related to PCT Application No. PCT/IB2018/056709, filed Sep. 3, 2018 which also claims priority to U.S. Provisional Patent Application No. 62/553,694, contents of which is hereby incorporated in its entirety as if fully set forth herein.

### TECHNICAL FIELD

Various embodiments of the present disclosure relate generally to the remote content access, transmission, and utilization and systems and methods.

### BACKGROUND

Video content has historically been delivered to consumers in a variety of ways. For example, television can be broadcast over the air or delivered by cable subscription. Alternatively, numerous internet-based content delivery systems also exist that provide access to video content. These include streaming TV services that deliver both live and on-demand content, as well as those that provide offline content.

In many developing markets, media consumers are more likely to own a mobile phone with internet capability than they are to own a television, or subscribe to a pay TV service. Additionally, many users do not own a credit card or have easy access to credit. Instead, these users frequently use a pay-as-you-go system to pay for their mobile phone use. In many of these markets, the cost of high-speed wireless service is relatively low, and thus many users use their phones to consume video. At present, few options exist to view licensed video content, and thus many users view unlicensed, pirated video content. A system is therefore needed that delivers a wide range of video products to mobile users. A system is further needed that can allow users to compensate content owners for viewing their content, either through advertising or direct payments. Moreover, related art systems have a number of inefficiencies, especially when confronted with large-scale streaming and sharing of content.

Aspects of the present disclosed technology address one or more of these issues. A system or method for mobile content delivery in accordance with an embodiment can give consumers both content and the data service to view it for free. It can give service providers supplemental revenue, and it can provide content owners with the ability to control content delivery and to monetize their content.

What is needed, therefore, is the technology disclosed herein. Embodiments of the present invention address this need as well as other needs that will become apparent upon reading the description below in conjunction with the drawings.

### SUMMARY

There is provided systems, methods, and computer-readable mediums that address certain aspects discussed above. An embodiment is provided for providing streaming of live and recorded content via a streaming application to a user device. An embodiment provides novel and non-obvious user interfaces, transitions, overlays, and enhancements that improve system functionality and ease of use. An embodiment includes overlaying an interactive link on a first video. When the interactive link is selected, the first video is paused, and a second video associated with the link is output. When the second video is completed, the first video resumes. In an embodiment, a user would like to share the streaming application. The user selects a sharing option, and then indicates through which channel they would like to share. A message is generated and formatted in accordance with the selected channel. In an embodiment, formatting comprises adding video, text, and/or images as appropriate for the selected channel. According to an embodiment, a chatbot interface is provided that requests user information. The questions may be general or tailored to content viewed through the streaming application. The chat interface may be regularly initiated to unobtrusively gain insight into the user. In an embodiment, a user received rewards points for viewing advertisements, sharing the streaming application and/or providing user information. The reward points may be redeemed through a catalog and/or through a bidding process.

In an embodiment, there is provided a chatroom interface for chatrooms corresponding to particular content. Access to the chatroom may be limited to current viewers of a video. In an embodiment, past conversations (e.g., chat inputs of previous viewers of content) may be replayed in time with a user's viewing of the video.

In an embodiment, while viewing a video, a sharing option is selected. A portion of the video (e.g., a clip) is package along with the sharing of the content (e.g., a link to the content). The portion of the video may be retrieved from volatile memory (e.g., of a device of the user sharing the video).

In addition to the foregoing, various other method and/or system and/or program product aspects are set forth and described in the teachings such as text (e.g., claims and/or detailed description) and/or drawings of the present disclosure.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

In one or more various aspects, related systems include but are not limited to circuitry and/or programming for effecting herein-referenced method aspects; the circuitry and/or programming can be virtually any combination of hardware, software, and/or firmware configured to affect the herein-referenced method aspects depending upon the design choices of the system designer. In addition to the foregoing, various other method and/or system aspects are set forth and described in the teachings such as text (e.g., claims and/or detailed description) and/or drawings of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 depicts a user interface in accordance with an embodiment.

FIG. 2 depicts a user interface used to select additional videos.

FIGS. 3A and 3B depict main menus in accordance with an embodiment.

FIG. 4 depicts an ad controller user interface in accordance with an embodiment.

FIGS. 5A and 5B depict social media user interfaces in accordance with an embodiment.

FIG. 6 depicts a channel mixing user interface in accordance with an embodiment.

FIG. 7A-7F depict video and ad playing interfaces in accordance with an embodiment.

FIG. 8 depicts a television connection interface in accordance with an embodiment.

FIG. 9 depicts a playlist browser interface in accordance with an embodiment.

FIG. 10 depicts an offline download user interface that is displayed as a user is downloading content for viewing offline later in accordance with an embodiment.

FIG. 11 depicts a user interface in accordance with an embodiment.

FIG. 12 depicts a movie selection interface in accordance with an embodiment.

FIG. 13 depicts a user interface in accordance with an embodiment to provide a content search.

FIG. 14 depicts a user interface in accordance with an embodiment.

FIG. 15 depicts an interface for a chat feature in accordance with an embodiment.

FIGS. 16A and 16B depict interfaces for a group chat feature in accordance with an embodiment.

FIGS. 17A-17C depict interfaces of a user profile and sharing a referral code in accordance with an embodiment.

FIGS. 18-19B depict chatbot interfaces in accordance with an embodiment.

FIG. 20 is a block diagram of an illustrative computer system architecture, according to an example implementation.

FIG. 21 is an example environment in which one or more aspects of the present disclosure may be implemented.

The accompanying drawings, which are incorporated in and constitute a part of this specification, illustrate multiple embodiments of the presently disclosed subject matter and serve to explain the principles of the presently disclosed subject matter. The drawings are not intended to limit the scope of the presently disclosed subject matter in any manner.

### DETAILED DESCRIPTION

Although preferred embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the preferred embodiments, specific terminology will be resorted to for the sake of clarity.

It should also be noted that, as used in the specification and the appended claims, the singular forms “a,” “an” and “the” include plural references unless the context clearly dictates otherwise. References to a composition containing “a” constituent is intended to include other constituents in addition to the one named.

Also, in describing the preferred embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

It is also to be understood that the mention of one or more method steps does not preclude the presence of additional method steps or intervening method steps between those steps expressly identified. Moreover, although the term “step” may be used herein to connote different aspects of methods employed, the term should not be interpreted as implying any particular order among or between various steps herein disclosed unless and except when the order of individual steps is explicitly required.

The components described hereinafter as making up various elements of the invention are intended to be illustrative and not restrictive. Many suitable components that would perform the same or similar functions as the components described herein are intended to be embraced within the scope of the invention. Such other components not described herein can include, but are not limited to, for example, similar components that are developed after development of the presently disclosed subject matter.

To facilitate an understanding of the principles and features of the invention, various illustrative embodiments are explained below. In particular, the presently disclosed subject matter is described in the context of video content delivery systems. The present invention, however, is not so limited, and can be applicable in other contexts. For example, and without limitation, some embodiments of the present invention improve content distribution systems for other kinds of media and the like. These embodiments are contemplated within the scope of the present invention. Accordingly, when the present invention is described in the context of video content delivery, it will be understood that other embodiments can take the place of those referred to.

Aspects of the present technology relate to a system for delivering content to mobile devices. For example, in many parts of the world, more consumers have access to smartphones and high-speed wireless internet than have access to paid TV, either through internet service providers, or traditional cable providers. As a result, there is a need for a content delivery platform that provides an easy means of providing content to users, and a way to monetize that content.

Aspects of the present invention address these problems. For example, an embodiment application provides multiple types of video content. These types of video content can include (1) Advertising sponsored video (AVoD), (2) Subscription Video Channels (SVoD), (3) Free to Air Channels (FTA), and (4) Pay Per View (PPV). AVoD and PPV content are available in an on-demand format, allowing users to select content to watch at any time. SVoD and FTA channels are continuous broadcast media similar to ordinary television.

In some embodiments, video content can be delivered to the mobile device of a user. In some embodiments, the video can be interrupted with commercial advertising supplied by a content provider. In some embodiments, those interruptions occur during what would normally be commercial breaks. For example, if an application is displaying a live format video, the application may substitute existing commercial breaks for other commercial advertisements. Alternatively, if the video playing is pre-recorded, commercial advertising can be displayed when commercial breaks would normally be displayed during a broadcast of the video, or at any other time. In some embodiments, the commercial advertising displayed as a video is playing is provided by an advertising platform. In some embodiments, that advertising platform can be connected with one or more advertising exchanges to supply advertising content.

In some embodiments, users can pay for certain kinds of content, such as PPV and SVoD video content. In some embodiments, payments can be implemented as micro transactions charged through the user's mobile service provider. In some embodiments, the application can select advertising based on the user's proximity to certain locations. For example, if a user walks by a particular clothing store, the application can play an advertisement for that clothing store. However, such geographic advertising methods need not be related to the proximity to a store, but can be to any location and the advertisement from any company or product.

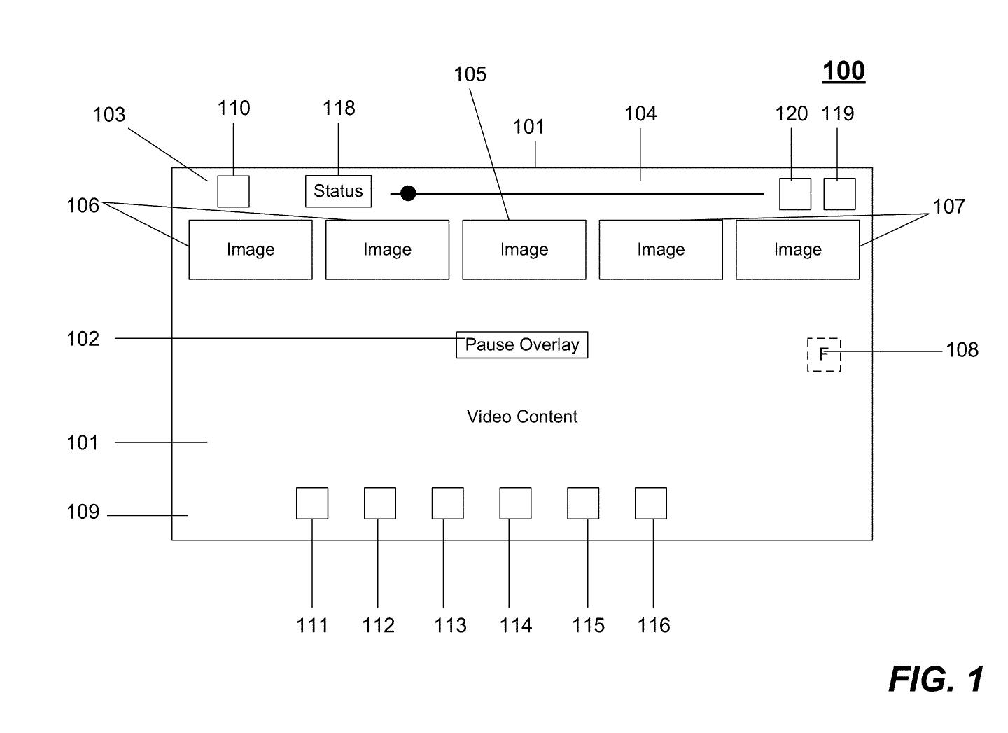

FIG. 1 depicts a user interface 100 in accordance with an embodiment. In user interface 100, a user can pause playing video 101 to show the main menu. While the main menu is displayed, the video can be paused, and can display a visual indication that the video is paused 102. In some embodiments, the video continues to play while the interface 100 is displayed. A top menu bar 103 allows a user to see the progress of the current video as a progress bar 104, and as an elapsed time, a menu icon 110, a status icon 118, other settings 119 (e.g., video quality, subtitles, language settings, and audio settings), and channel mode 120. The status icon 118 may indicate whether video 101 is, for example. live, recorded, video-on-demand, or downloaded. The channel mode 120 may include some or more modes, for example, top channels (e.g., Top 12 Channels, Shuffle, and Mood Playlist). Top 12 Channels presents one or more channels selected by a user. In a case where a user has not selected a predetermined number of channels, recommended channels may be included with the top channels. Shuffle mode shuffles videos (e.g., all content, by type, or some other criteria). In some cases, a next-video is selected pseudo-randomly from all relevant channels after a current video is completed. The top menu bar 103 can further include a playlist bar that can include images representing the video currently playing 105, the videos previously played 106, and the videos coming up next 107. In some embodiments, a social media logo can be displayed on the screen to allow a user to quickly post the video to a social media platform.

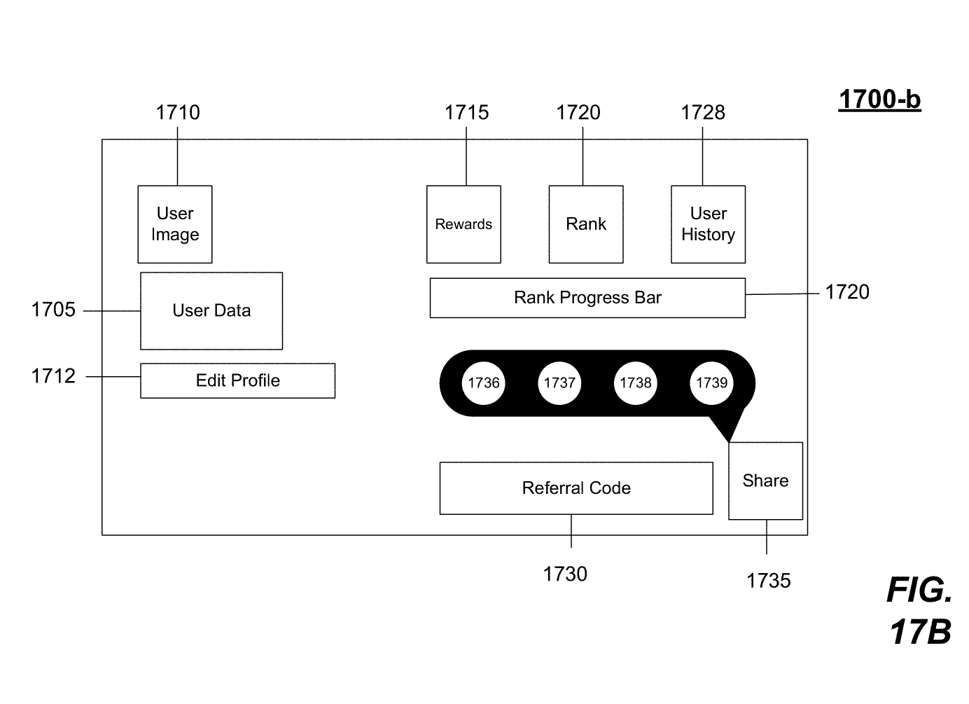

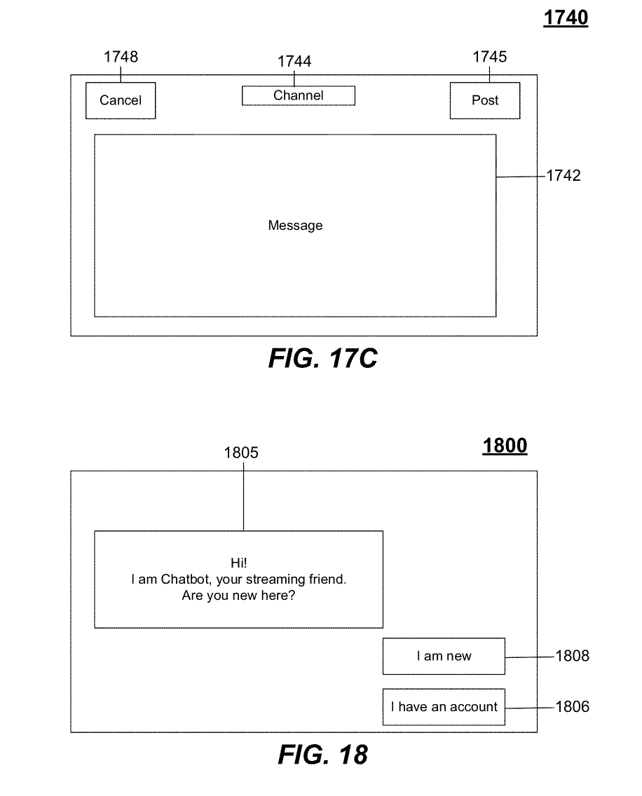

In an embodiment, a lower menu bar 109 can also be displayed. This lower menu bar 109 can provide access to other features, channel viewer chatroom 111 (e.g., enter a chatroom for users currently watching a same program), channel program guide 112 (e.g., showing live channel showtimes), sharing 113 (e.g., social media sharing), sharing referral code with friends 114 (see, e.g., FIGS. 17A-17C), screen capture and editing 115, and search 116. Search 116 may enable a user to search for content based on, as non-limiting examples, a channel, an episode, a type (e.g., sports), a description (e.g., soccer), and/or status (e.g., live, recorded, etc.). As would be understood by a person of ordinary skill in the art, the user interface of FIG. 1 is an example of an interface in accordance with an embodiment, although other user interfaces are contemplated within the scope of the disclosed technology. For example, in some cases, menu 103 or 109 may provide functions such as full-screen view, messaging, movies, television integration, and offline downloading.

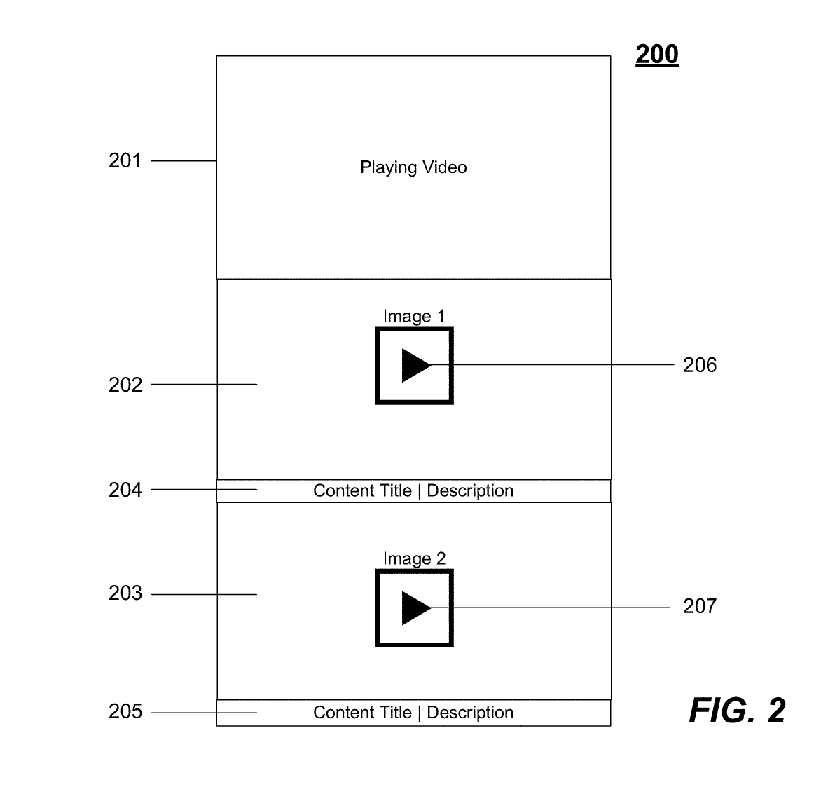

FIG. 2 depicts a user interface 200 used to select additional videos. In some embodiments, this interface can be displayed when a user rotates the phone from a horizontal orientation to a vertical orientation. When the phone is rotated, the video can continue to play in a top pane 201. In addition, information about other videos can be shown below in panes 202 and 203. Videos displayed in panes 202 and 203 may include textual descriptions of the videos 204 and 205, indicating the source or title of the video. As would be understood by a person of ordinary skill in the art, the arrangement of the three panes is an example, although other configurations could be used without departing from the invention. For example, the playing video could be displayed in lower pane 203 or middle pane 202, with the other videos shown in the remaining panes. The videos displayed in panes 202 or 203 can be upcoming videos in the sequence of videos to be played, previously shown videos, videos related to the currently playing video, or combinations thereof.

In some embodiments, graphical icons may be displayed in panes 202 and 203 to describe the videos. For example, pane 202 has an icon labeled “NEXT” to indicate that the video shown will be the next video played. In some embodiments, the videos in panes 202 and 203 can have play buttons in the center of the videos 206, 207. If a user selects the play icon, the selected video will begin playing in the top pane. In some embodiments, the pane where the newly-playing video was described will be replaced with an additional suggested video. In some embodiments, the originally playing video will stop playing, and the newly selected video will begin playing in its original pane (e.g., pressing play button 206 causes the newly selected video to begin playing in pane 202). In some embodiments, the newly playing video will slide from its pane up to the top pane as a transition animation. In some embodiments, the additional videos displayed in panes 202 and 203 can be the next two videos to be played. In some embodiments, the additional videos displayed can be videos selected based on the currently displayed video, set by a users' video queue, or a suggestion based on previously watched videos, a user's profile, or other data. In some embodiments, the panes showing other videos 202, 203 further include a play button 206, 207. As would be understood by a person of ordinary skill in the art, the user interface of FIG. 2 is an example of a user interface in accordance with an embodiment, although other user interfaces are contemplated within the scope of the disclosed technology.

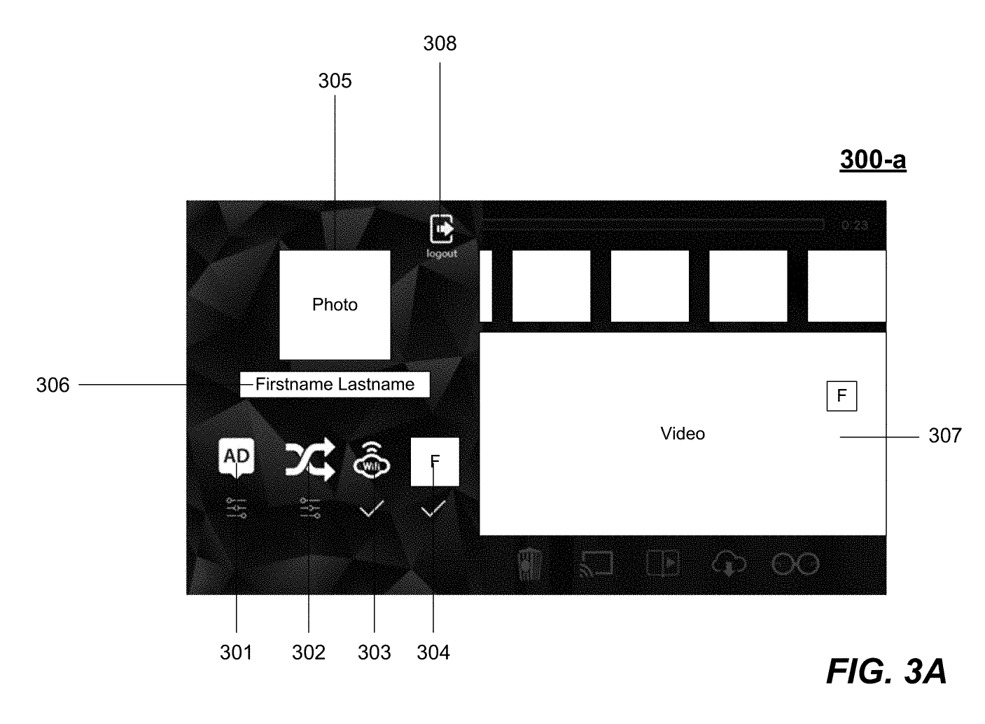

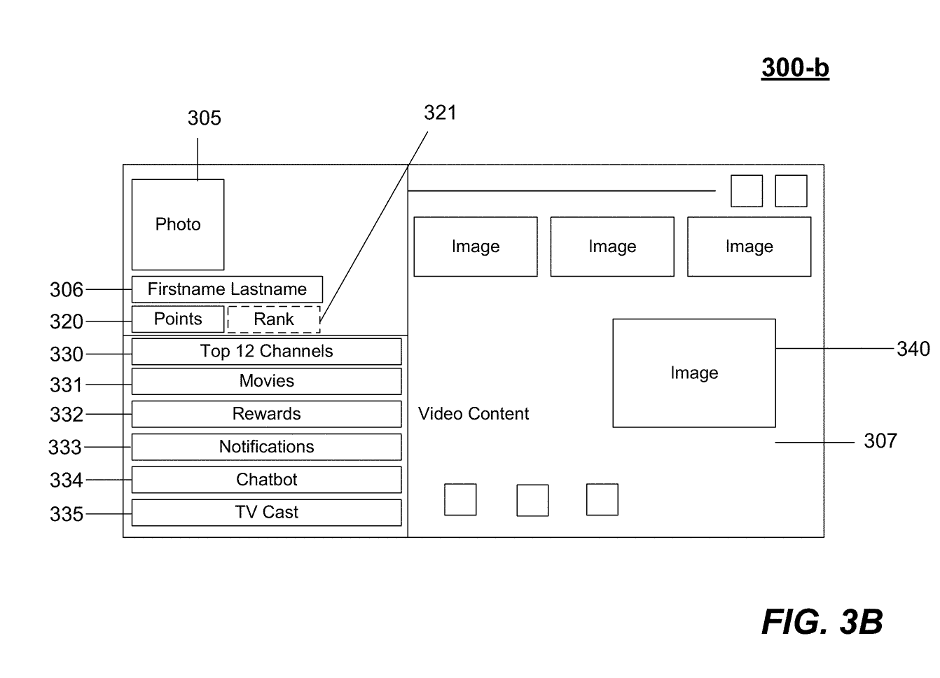

FIG. 3A depicts a main menu 300-a in accordance with an embodiment. In some embodiments, one or more other interfaces are accessible from the main menu. For example, a user can access an ad controller 301 and channel mixer 302. Additionally, one or more program settings can be enabled or disabled from the main menu, such as WiFi 303, or social media integrations 304. Additionally, the main menu can depict user profile information such as a profile picture 305 and username 306. A logout option 308 can also be included in some embodiments. In some embodiments, the main menu can be a slide-over menu that covers a playing video 307. In some embodiments, the main menu can slide-over the video while it is paused. In some embodiments, sliding over the main menu pauses the video. In some embodiments, the user interface 200 can be shown behind the slide-over main menu 300-a. In some embodiments, the video and/or menu displayed underneath the main menu can be dimmed or darkened while the main menu is displayed. In some embodiments, the main menu can be dismissed by a user touching and sliding their finger to the edge the menu slid-over from. In some embodiments, the main menu can be accessed by sliding a finger in from an edge towards the center of the video from a preselected edge or edges.

FIG. 3B depicts a main menu 300-b in accordance with an embodiment. One or more other interfaces are accessible from the main menu. For example, a user can access Top Channels 330, Movies 331, Rewards 332, Notification 333, Chatbot 334, and TV Cast 335. Additionally, the main menu can depict user profile information such as a profile picture 305, username 306, total points 320 and current rank 321. The main menu can be a slide-over menu that covers a playing video 307. Sliding over the main menu may pause the video. An image 340 of a next video may also be displayed. In some embodiments, the video 307 and/or menu displayed underneath the main menu can be dimmed or darkened while the main menu is displayed. As would be understood by a person of ordinary skill in the art, the user interface of FIGS. 3A and 3B are an example of a main menu in accordance with an embodiment, although other user interfaces are contemplated within the scope of the disclosed technology.

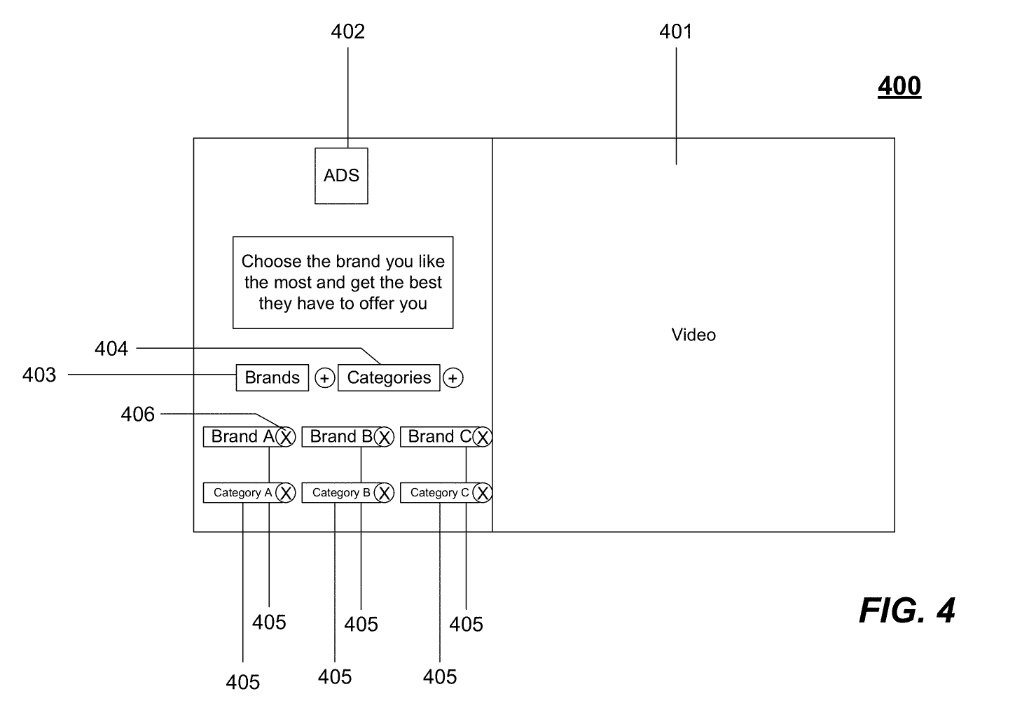

FIG. 4 depicts an ad controller user interface 400 in accordance with an embodiment. The ad controller allows users to identify brands or products that they find interesting. In some embodiments, the user interface 400 is available as a slide-over menu over a playing video 401. In some embodiments, the application will only display ads from companies, brands, or products identified by a user. In some embodiments, the application will display ads from companies, brands, products, or combinations thereof more frequently than ads from those not selected by a user. In some embodiments, users can select categories of companies, brands, or products that will then be displayed more frequently than others. In some embodiments, the ad controller comprises a title icon 401. In some embodiments, graphical icons and/or text are displayed that allows a user to add an advertising source by category, such as brand 402 or product category 403 (e.g., golf). In some embodiments, the selected advertising categories can appear as icons 404 labeled with the advertising category. In some embodiments, the icons 404 include a button 405 to delete the icons 404 from the ad controller. In the embodiment depicted in FIG. 4, the button to delete is shown as an “X” next to each advertising category. As would be understood by a person of ordinary skill in the art, the user interface of FIG. 4 is an example of an ad controller in accordance with an embodiment, although other user interfaces are contemplated within the scope of the disclosed technology.

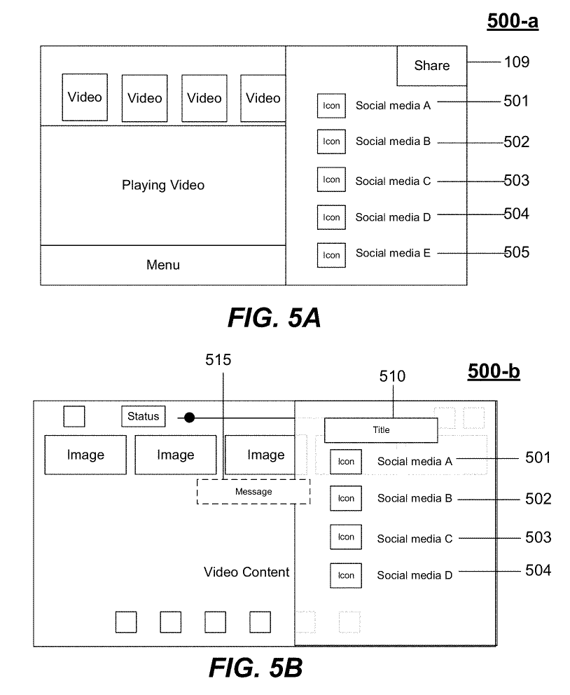

FIG. 5A depicts a social media user interface 500-a in accordance with an embodiment. A user may wish to share the content he is currently viewing on one or more social media platforms, such as Facebook®, Line®, Facebook Messenger®, WhatsApp®, LinkedIn®, Instagram® or others. In some embodiments, a user can select from a plurality of icons that represent various social media platforms 501-505. In some embodiments, selecting the button for a social media platform will immediately trigger a post on the associated platform. For example, the system may post “I'm watching a great video called [Title]”, with the Title dynamically filled in for the currently-viewed video, and a link to the currently viewed video. In some embodiments, selecting the button for a social medial platform may trigger a new user interface to allow a user to input text correlated with the post. The user interface may be within the application, or may be provided by an external application associated with that social media platform. In some embodiments, a template may be provided for the text of the post, and/or a link to the content being viewed. In an embodiment, a user may capture a portion of the currently viewed video to include with the post. For example, when a user selects to share a video, a two-second clip of the video preceding the selection may be recorded and shared. In an embodiment, a system may access buffered or volatile memory storage of the video (e.g., recently displayed portions of the video), convert the volatile memory into persistent memory and share the persisted portion of the video. Accordingly, instead of purging buffers, an embodiment of the present disclosure maintains a buffer for a predetermined period of time (e.g., 2 seconds) after a video is displayed. This change to the video streaming architecture enables efficient use of resources while broadening previously available functionality.

FIG. 5B depicts a social media user interface 500-b in accordance with an embodiment. A user can select from a plurality of icons that represent various social media platforms 501-504. In some embodiments, selecting the button for a social media platform will immediately trigger a post on the associated platform. For example, the system may post “I'm watching a great video called [Title]”, with the Title dynamically filled in for the currently-viewed video, and a link to the currently viewed video. In some embodiments, selecting the button for a social medial platform may trigger a new user interface to allow a user to input text correlated with the post (see, e.g., FIG. 17C). The user interface 500-b may include a menu title (e.g., “Invite Your Friends”) and/or a message 515 (e.g., “Try sharing with your other accounts!”). User interface 500-b may overlay an underlying video and/or a main menu (FIG. 1).

In an embodiment, a user may edit a screen-capture in-app. For example, a user may modify the screen capture i-app to add stickers, emojis, text, and/or drawings to the screen capture prior to sharing. In some cases, the screen capture may be linked to the captured video and/or the user's referral code.

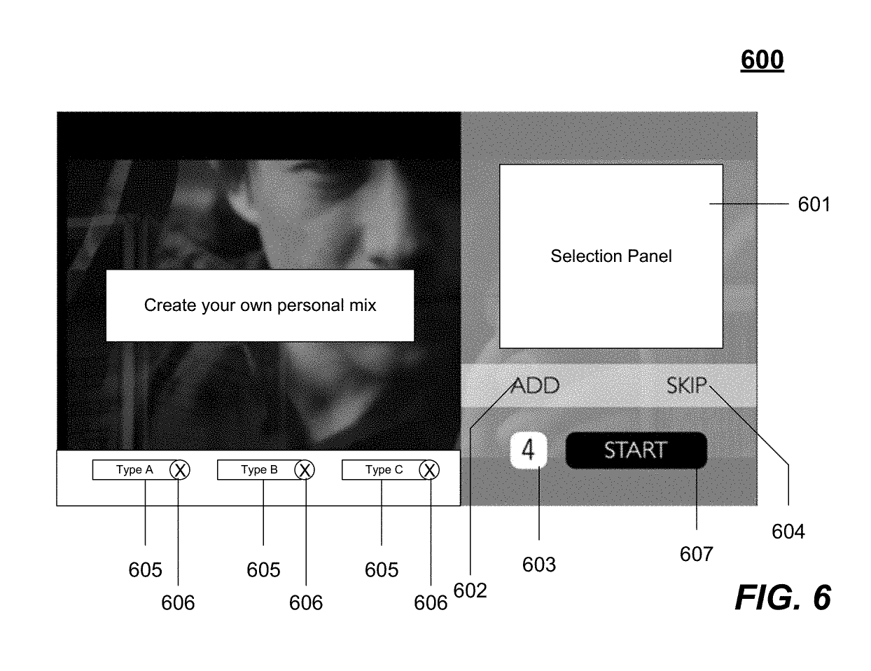

FIG. 6 depicts a channel mixing user interface 600 in accordance with an embodiment. Some embodiments of the present technology include a channel mixer 600 that allows users to customize the content of a video channel. A user is presented with an interface that allows them to select types of content. Types of content may be a content provider, television channel, television show, content category, and a specific video, among others. An image or text identifying a type of content will be displayed in the selection panel 601. A user can add that type of content to a channel mix by pressing the “add” button. The content will then be added to the channel mix. In some embodiments, a counter 603 will increment, showing that a type of content has been added to the channel mix. Once added, another type of content can be displayed in the selection panel. In some embodiments, a user can alternatively click a “skip” button 604 which will not add the type of content displayed to the channel mix. Instead, another type of content will be displayed in the selection panel 601. A user can see the types of content added to the channel as icons 605 which can include a text or image representation of the type of content. Each icon 605 includes a button 606 that will remove the type of content from the channel mix. If an item of content is removed, the counter 603 will decrement to show the total number of types of content in the channel mix. When a user indicates a desire to begin watching, such as by pressing a start button 607, the application will begin playing content consisting of a mix of the types of content selected by a user. In some embodiments, a user can select a channel mix based on a particular mood. For example, a user could select a feeling, such as happy, sad, not well, negativity, or very positive, and view content matching the indicated mood. As would be understood by a person of ordinary skill in the art, the user interface of FIG. 6 is an example of a channel controller in accordance with an embodiment, although other user interfaces are contemplated within the scope of the disclosed technology.

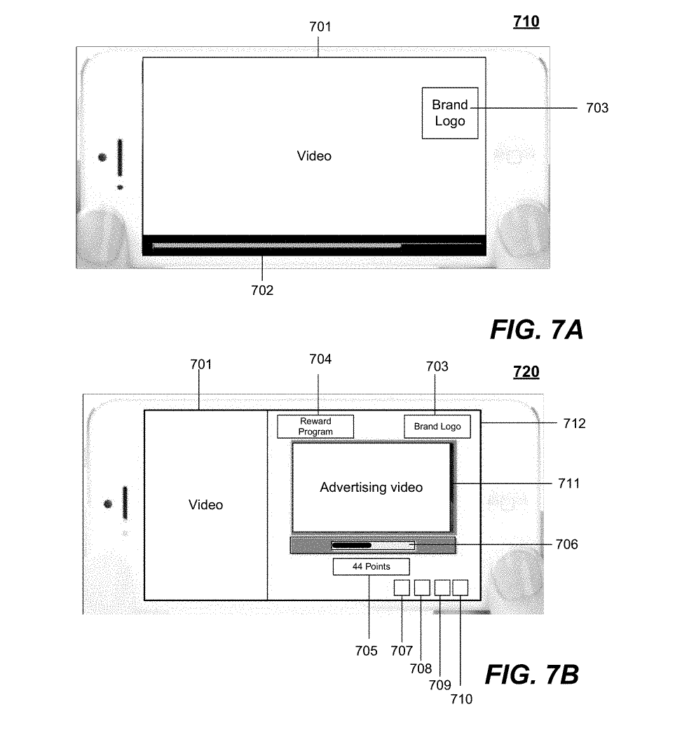

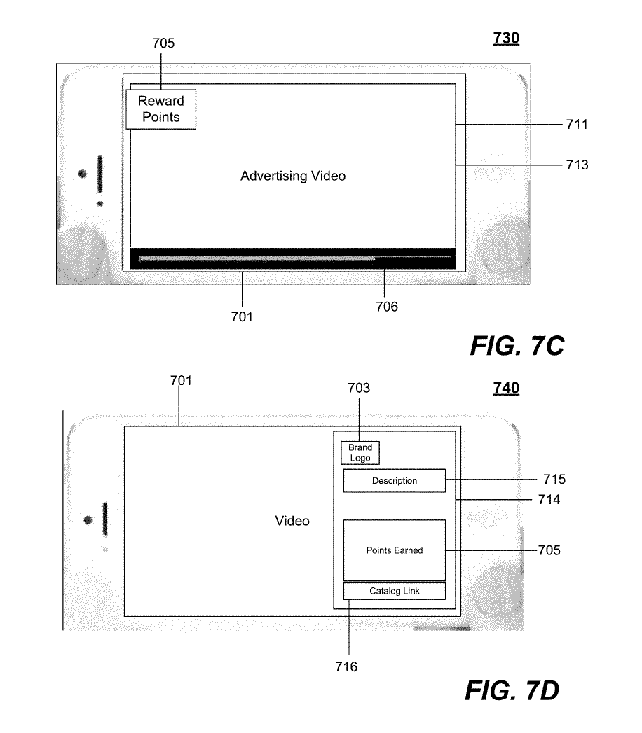

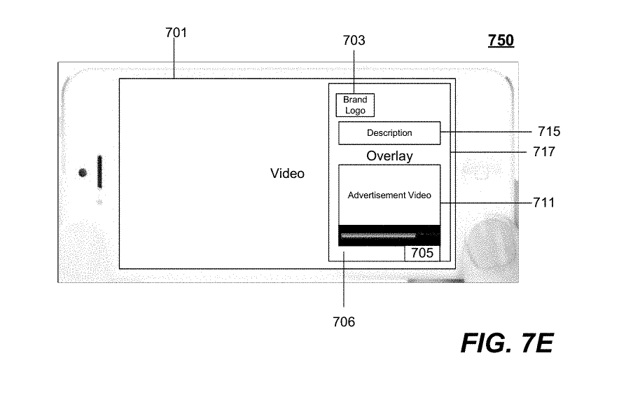

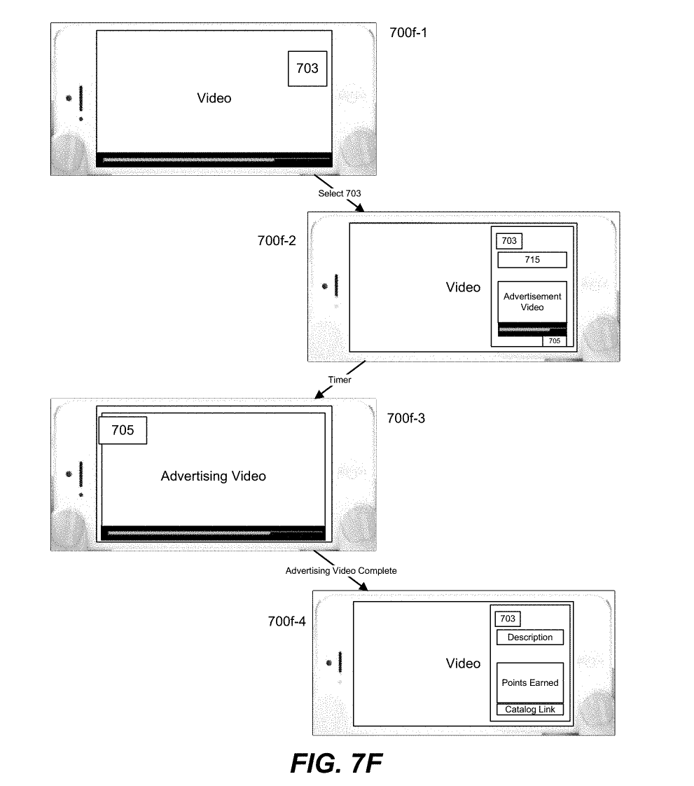

FIG. 7A depicts a video playing interface in accordance with an embodiment. In some embodiments, when a video is playing, the video 701 will occupy the majority of the screen space. In some embodiments, the interface can include a progress bar 702. In some embodiments, an interactive link (e.g., logo associated with a sponsor) can be displayed over the video, such as in the upper right corner 703. In some embodiments, a single logo can be displayed for the entire duration of the video. In some embodiments, the logo can change, showing different logos based on intervals of time. For example, in some embodiments, the icon can be displayed for 30 seconds and then be removed or replaced with another image. In some embodiments, the logo can change after a user has interacted with the logo, such as by clicking on it. In some embodiments, a message 704 can also be displayed over the video to indicate an action that occurs when the logo is clicked. In some embodiments, the message 704 can scroll across the bottom of the screen. In some embodiments, the message 704 can be displayed at regular intervals. In some embodiments, the logo 703 can change after it is interacted with by the user, such as by clicking it. As a non-limiting example, selecting the interactive link 703, the video 701 may be paused, muting, and/or faded and an ad interface (e.g., 712 of FIG. 7B) may overlay video 701.

FIG. 7B depicts an ad-playing interface in accordance with an embodiment. In some embodiments, the ad-playing interface is a slide-over interface over a playing video 701. In some cases, ad-playing interface 712 may overlay video 701 or compress video 701. The interface can display a logo 702 associated with the advertisement video 711. In some embodiments, the ad-playing interface 712 can be associated with a rewards program. For example, a user can earn rewards (e.g., points, virtual coins, etc., hereafter “points”) by watching an advertisement 711 from a sponsor that can then be spent on rewards. In some embodiments, the number of points awarded can be proportional to the portion of the video watched. For example, if the entire advertisement is worth 50 points, a user can earn 25 by watching half of the advertisement. In some cases, a portion of the advertisement points may be earned over time, and a portion of the total points may be awarded upon completion of the advertisement video (e.g., a user can earn 20 for watching each half of the advertisement and 10 points for completing the video), interacting with the advertisement (e.g., answering a question or selecting an option), or completion of some other goal (e.g., selecting a link within the advertisement).

In some embodiments, a logo associated with the rewards program 704 can be displayed in the interface. In some embodiments, the number of points 705 associated with the video can be displayed on the interface 712. In some embodiments, a progress bar 706 is provided on the interface, which shows the progress of the video. In some embodiments, a link to the user's wallet of earned points can be provided through an icon 707. Additionally, icons may be included to allow a user to share the advertising on their social media accounts 708-710. In some embodiments, additional rewards points can be awarded for sharing advertising on social media.

FIG. 7C depicts a second ad-playing interface 713 in accordance with an embodiment. In some embodiments, ad-playing interface 712 may be displayed for a certain period of time (e.g., 5 seconds), before expanding into ad-playing interface 713. In ad-playing interface 713, advertisement video 711 is expanded to be substantially full-screen, and cover video 701. Progress bar 706 is below advertisement video 711, and a number of points 705 (e.g., earned points) is displayed, for example, in the upper left corner of advertising video 711.

After the video is complete, an ad-complete interface 714 may be displayed, for example, as shown in FIG. 7D. Referring to FIG. 7D, when advertisement video 711 is finished, the number of points 705 earned for watching the entire video may be displayed in an overlaid interface 714. Interface 714 may display logo 703 and description 715 of the completed advertisement video 711, and a link 716 to a catalog for redeeming points 705. The catalog may include, as non-limiting examples, discounted products (e.g., the discount being purchased with rewards points), sample products purchasable with rewards points, access to content (e.g., temporary access to paywall episodes or channels). In an embodiment, the catalog is categorized and searchable based on one or more of name, category, rewards cost, currency cost (where applicable), and MSRP or fair-market value. In an embodiment, items and/or discounts may be bid upon using reward points. In some cases, a certain number of rewards may be required to execute a bid on an item.

FIG. 7E depicts an alternative ad-playing interface 717 according to an embodiment. For instance, when a user selects logo 703 displayed on video 701 in FIG. 7A, ad-playing interface 717 may be initiated. Ad-playing interface 717 may display advertisement video 711, progress bar 706, logo 703, and description 714 of the advertisement video 711. Ad-playing interface 717 may expand into ad-playing interface 713 (e.g., after a pre-determined period of time), or advertisement video 711 may complete playing in interface 717.

FIG. 7F illustrates an interface flow according to an embodiment. In 700f-1, a video 701 is playing. Logo 703 is selected, and ad-playing interface 717 is activated (700f-2). Video 701 may be paused, muted, and/or dimmed. After a preset period of time (e.g., 3 seconds), advertisement video 711 is expanded into ad-interface 713 (700f-3), illustrating a full-screen or substantially full-screen ad. Once advertisement video is complete, ad-interface 714 is transitioned to (700f-4). Video 701 may resume after completion of advertisement video 711. In a case of live content, video 701 may resume at a same point as when advertisement 711 was activated or skip to a current live point in video 711.

In an embodiment, the system tracks various aspects of user interaction with advertising videos and/or logos. For example, in an embodiment, the system tracks one of ore of which logos were displayed to the user, which logos were selected by the user, how long each advertising video was viewed by the user, what a user was watching when the logo was shown (e.g., both selected an unselected), when the logo was shown (e.g., time of day, day of week, time in video), and whether a user responds to the advertisement (e.g., whether a user makes a purchase after being shown an advertisement). In an embodiment, the system analyzes the tracked data to determine better advertisements to show the user and better times to show the user advertisements.

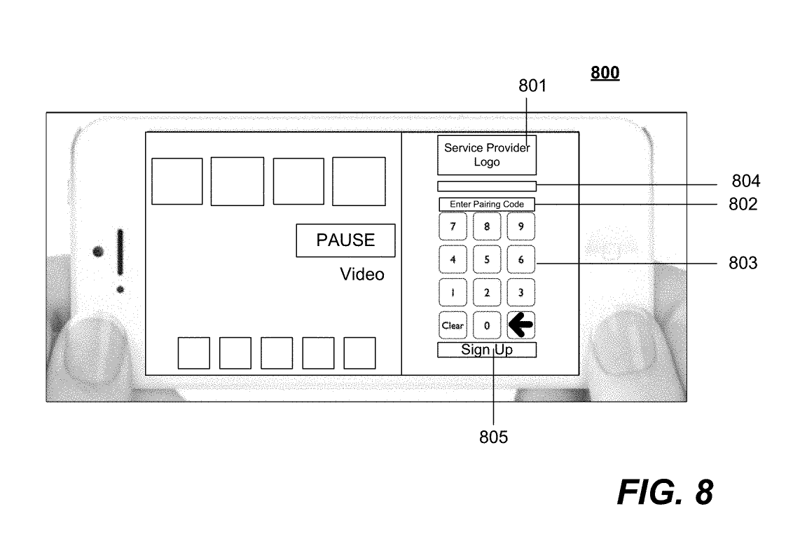

FIG. 8 depicts a television connection interface 800 in accordance with an embodiment. In some embodiments, the application can play video on a user's television. To accomplish this functionality, a user can obtain a pairing code from their television service provider. For example, a user may have a set-top box that can pair with the application that can generate a pairing code. In some embodiments, the pairing code can be activated with a unique user ID provided to the user, which, as another example, a user can log on to a website associated with their television provider and obtain a code. Once a pairing code is obtained, a user can open the television connection interface 800. A logo associated with a service provider can be displayed on the interface 801. In some embodiments, a help icon 802 can be displayed that, when clicked, will provide a user with instructions enabling them to obtain a pairing code. In some embodiments, the pairing code can be a unique code generated online and displayed at a specified URL. In some embodiments, once a code has been obtained, the user can enter the code using a graphical number keypad 803. Alternatively, in some embodiments, a user can enter a pairing code using a keyboard provided by the operating system of the mobile device. In some embodiments, as the user enters the pairing code, the digits previously entered will appear in a display window 804. Once the pairing code is completely entered, a user can select a “sign-up” button 805 that will enable video displayed on the mobile device to be displayed on a television.

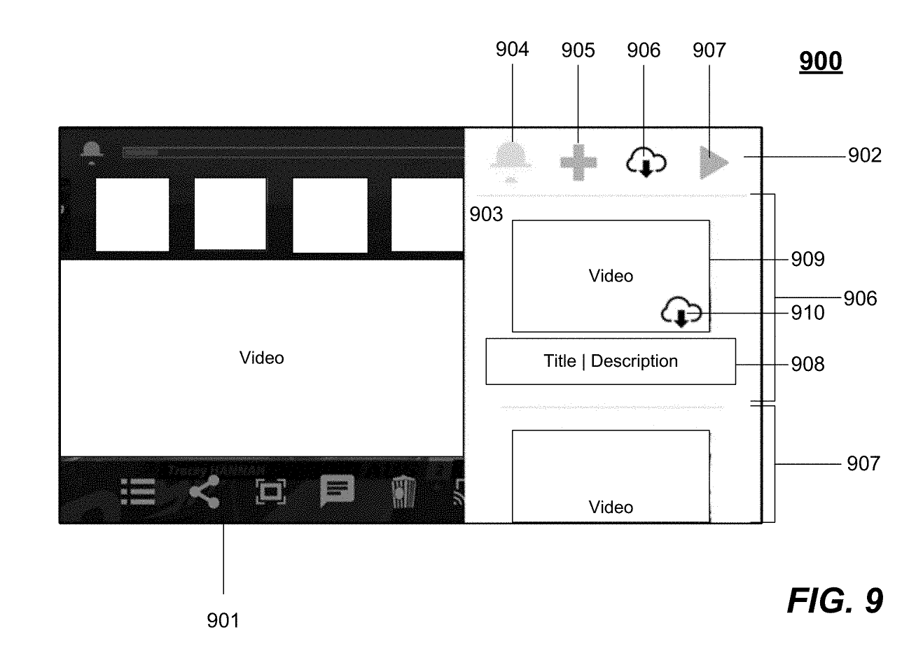

FIG. 9 depicts a playlist browser in accordance with an embodiment. In some embodiments, the user interface 900 can slide over a video 901. In some embodiments, the playlist includes a top button row 902 and a scrolling feed 903. In some embodiments, the button row can contain a main menu icon 904 that returns a user to the main menu. In some embodiments, the button row can include a button to add videos 905 that allows a user to include additional videos in the scrolling feed 903. In some embodiments, the button row includes an offline download icon 904 that, when pressed, will cause the application to download the video content associated with the scrolling feed 903. In some embodiments, the button row includes a play button 904 that, when pressed, will cause the application to begin playing content associated with the feed 903. The scrolling feed can include panels 906-907 that display content associated with a video. This content can include a textual title or summary 908 and/or a still graphical image 909 associated with video content. In some embodiments, the panels 906-907 can further include an offline download button 910 that, when pressed, will begin downloading the associated video to the mobile device. In some embodiments, the videos included in feed 903 are videos that have been downloaded for offline viewing.

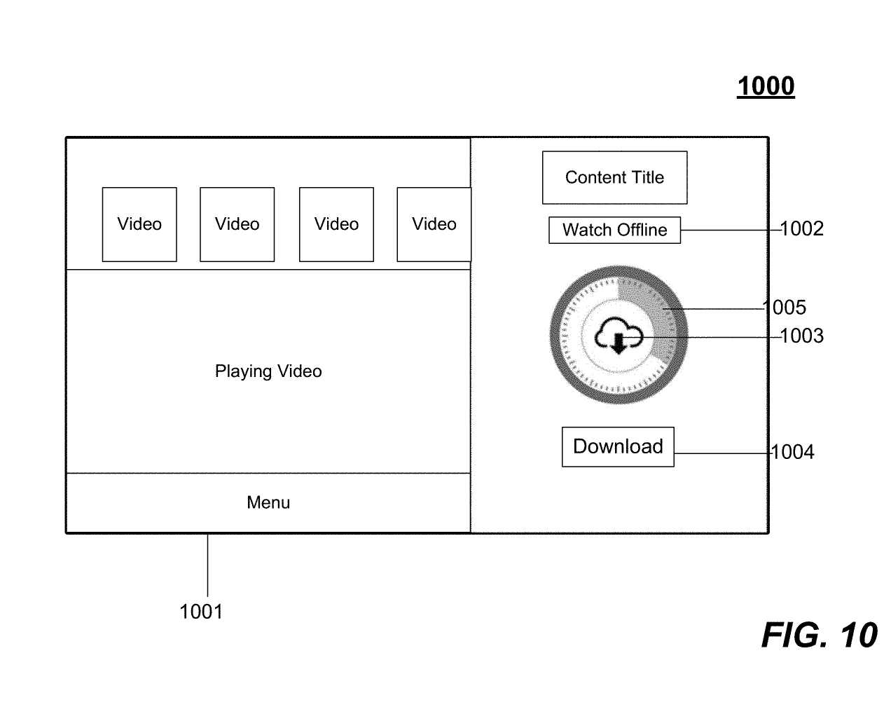

FIG. 10 depicts an offline download user interface 1000 that is displayed as a user is downloading content for viewing offline later. In some embodiments, the interface 1000 is displayed as a slide-over panel over a running video 1001. In some embodiments, a title 1002 can be displayed to indicate the purpose of the user interface. In some embodiments, the user interface can include a graphical download icon 1003. In some embodiments, the user interface can include a textual icon 1004. In some embodiments, when a user clicks one of either a textual icon 1003 or a graphical icon 1005, the running video 1001 will begin to be downloaded to the mobile device. In some embodiments, other video content, such as a playlist or a video series, will begin downloading when one of a textual icon 1003 and a graphical icon 1005 is pressed. In some embodiments, a download progress widget 1006 indicates how much of the requested video content has been downloaded. In some embodiments, the widget can be a circular pie chart that fills in as the download completes. As would be recognized by a person of ordinary skill in the art, any other suitable download progress widget, such as a progress bar, percentage indicator, gauge, or other widget could likewise be used.

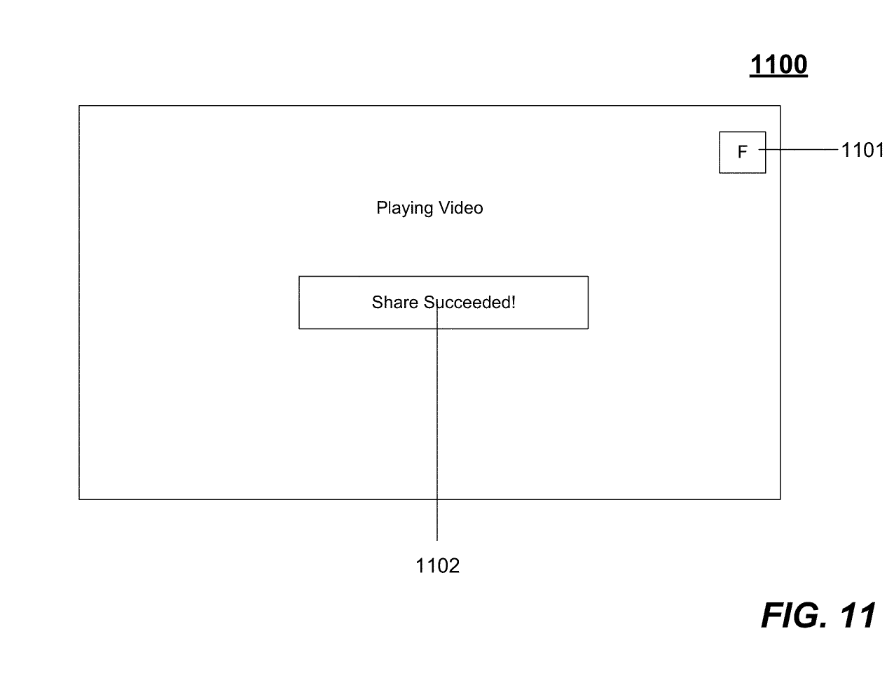

FIG. 11 depicts a user interface in accordance with an embodiment. In the window, a video is playing, and a button associated with a social media platform 1101 is displayed on the video. For example, the button can appear in the top right corner. When a user presses the button 1101, a message is posted to the indicated social media platform relating to the video. Confirmation that the post has been successfully made can then be indicated in a pop-up message 1102. In some embodiments, a user can click a screen capture button to pause the video and take a screenshot to be shared, for example, on a social media platform. In some embodiments, an annotation layer can be added to the screenshot, allowing a user to draw images or type text overlaid on the screenshot. For example, a user can add their own custom subtitle to a screenshot. Alternatively, a user can add a drawing to the screenshot using a pen or paintbrush user interface tool. Once the annotation layer is complete, a user can then share the annotated image on a social media platform.

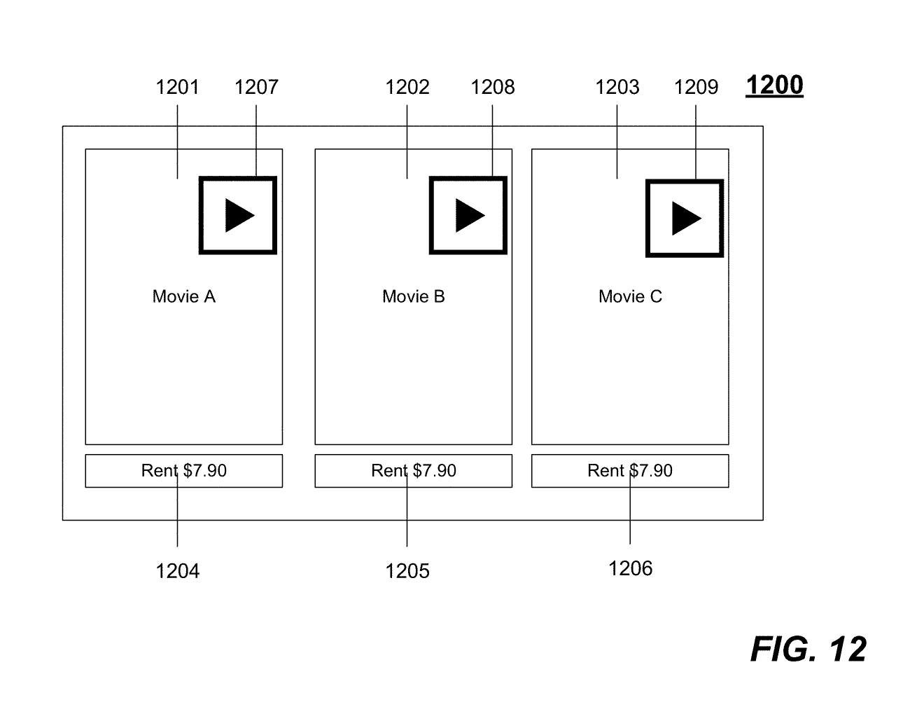

FIG. 12 depicts a movie selection interface 1200 in accordance with an embodiment. In this interface, a user can see the movie poster associated with various movies 1201-1203. Buttons appear below each movie poster indicating a price to rent the movie 1204-1206. When a user clicks on a movie poster, a trailer associated with the movie begins to play on the screen. In some embodiments, an icon 1207-1209 is displayed over the movie posters to indicate that clicking the posters will cause a video to begin playing. When a user presses the “Rent” button at the bottom of each movie, the movie will be made available to the user, and a micro transaction equal to the price of the movie will be made.

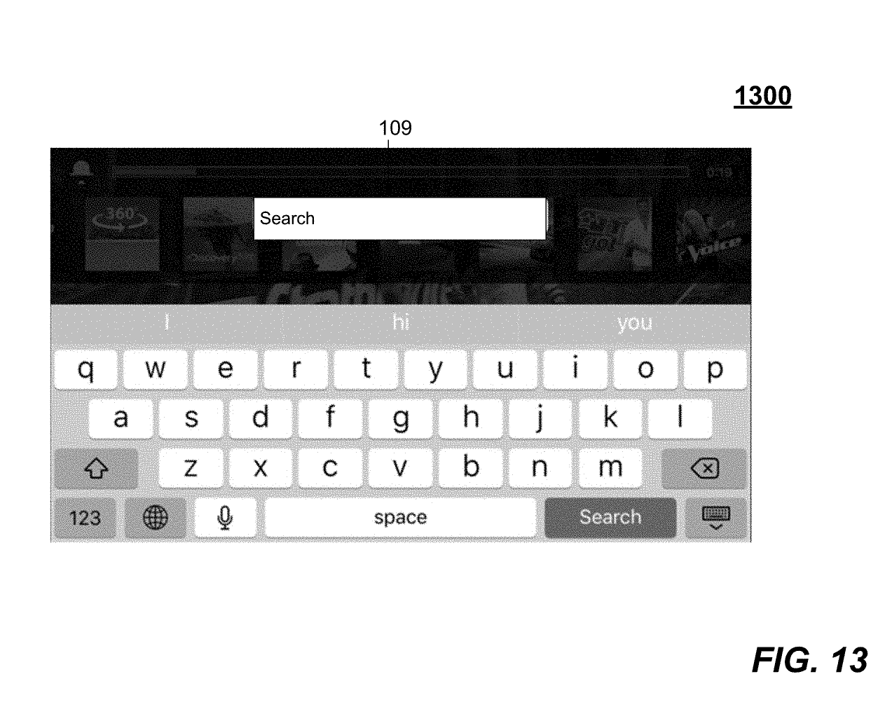

FIG. 13 depicts a user interface in accordance with an embodiment to provide a content search. A user can enter a search query into the box labeled “Search” and results will be displayed.

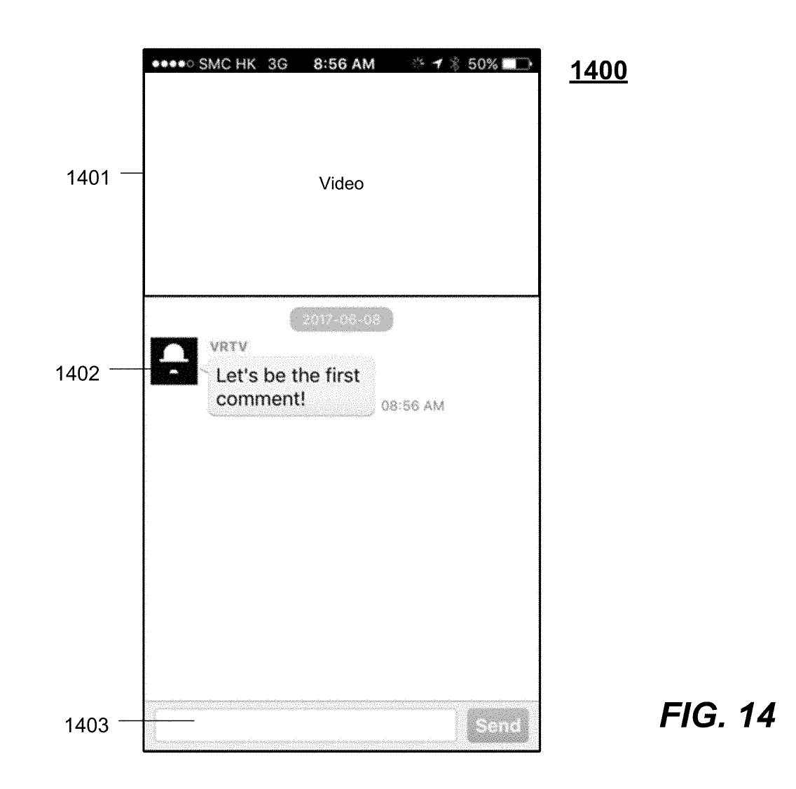

FIG. 14 depicts a user interface in accordance with an embodiment. This interface allows users to chat with one another about a video that is playing. In some embodiments, a user can visit this interface by selecting an appropriate button on the main menu 100, such as an icon depicting a messaging service 104. In some embodiments, a user can invite other people watching the video to their chat session. In some embodiments, messages are displayed next to an icon depicting the user who sent the message 1402. In some embodiments, a field is provided to enter and send messages 1403.

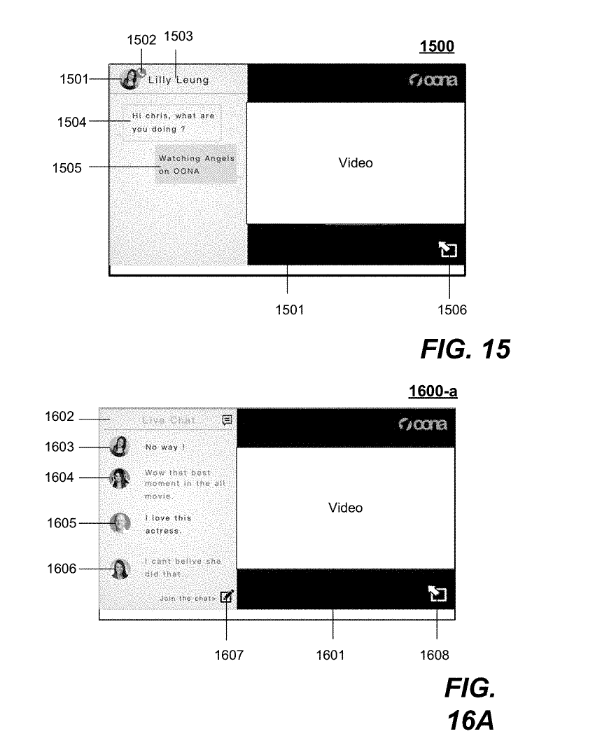

FIG. 15 depicts an interface 1500 for a chat feature in accordance with an embodiment. The user chats with one other selected user. In some embodiments, the interface includes a panel which displays a video 1501. In some embodiments, the interface includes an icon 1501 that can include a photograph of the selected user, and optionally may include an icon to indicate that an active connection has been made 1502. In some embodiments, the interface includes the name 1503 of the selected user. In some embodiments, messages sent from the other user 1504 appear in one color, and messages sent by the user of the interface appear in a different color 1505. In some embodiments, the interface includes an icon to make the video frame fill the screen 1501. In some embodiments, clicking the full-screen icon 1501 will end the chat. In some embodiments, clicking the full-screen icon 1501 will not end the chat. In embodiments where clicking the full-screen icon does not terminate the chat, subsequent received messages will arrive as notifications on the user's device. In some embodiments, those notifications may arrive through a notification system included in the application. In some embodiments, those notifications will appear through a notification system included in the mobile device's operating system.

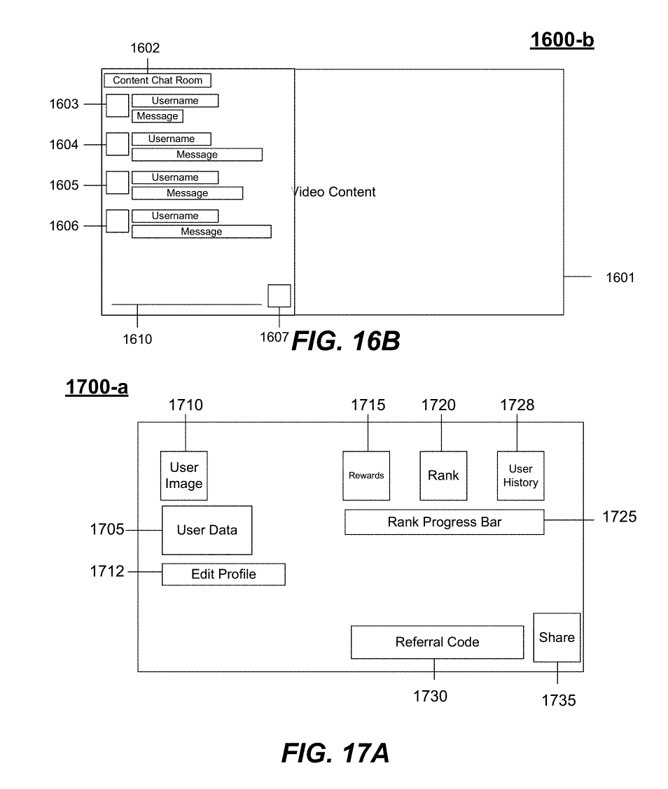

FIG. 16A depicts an interface 1600-a for a group chat feature in accordance with an embodiment. In some embodiments, the interface includes a panel which displays video 1601. In some embodiments, the interface includes a banner 1602 that indicates that a user is participating in a particular chatroom. In some embodiments, users who post messages in the chatroom 1603-06 will have their messages displayed adjacent to a photograph associated with the user. In some embodiments, users who post messages will have their messages displayed adjacent to a name associated with that user, such as a real name or a username. In some embodiments, a send message icon 1607 can be clicked to open a dialog to send a message to the chatroom. In some embodiments, a full-screen icon 1608 can be clicked to cause the video being played in the frame 1601 to enter a full-screen mode. In some embodiments, clicking the full-screen icon 1501 will end the chat. In some embodiments, clicking the full-screen icon 1501 will not end the chat. In embodiments where clicking the full-screen icon does not terminate the chat, subsequent received messages will arrive as notifications on the user's device. In some embodiments, those notifications may arrive through a notification system included in the application. In some embodiments, those notifications will appear through a notification system included in the mobile device's operating system.

FIG. 16B depicts an interface 1600-b for a group chat feature in accordance with an embodiment. In some embodiments, the interface 1600-b overlays video 1601 (e.g., interface 1600-b is at least partially translucent to video 1601). Interface 1600-b includes a banner 1602 that the user is participating in a particular chatroom. Messages are 1603-06 are posted in the chatroom, and may be displayed adjacent to an icon or photograph and username associated with the posting user. A message input 1610 may be selected to input a message for the chatroom and send message icon 1607 can be selected to send the message to the chatroom.

The chatroom may be specific to a particular video being currently watched by the user, the particular channel being watched by the user, or a particular category (e.g., sports or football). (e.g., admittance to the chatroom may be limited to current viewers of the related video). For example, the chatroom may be provided by a streaming application, and my only be accessed by current viewers of the content. In some cases, the streaming application may record conversations in the chatroom and replay/repost past comments for current viewers. In some cases, the comments may be timestamped or tagged to particular portions of the video content and reposted as the user views the particular portions of the video.

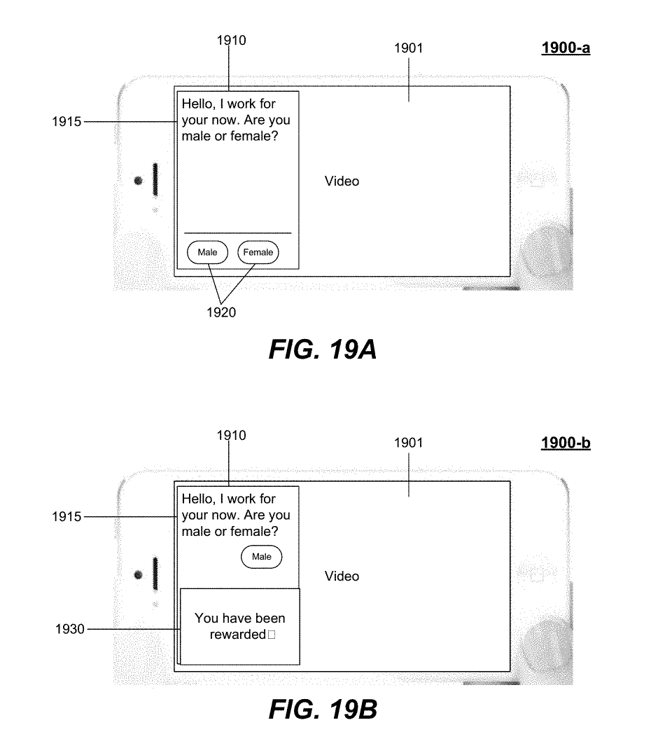

In some cases, chatbot (e.g., FIG. 19) may participate in the chatrooms and/or monitor the chatrooms to determine characteristics of the user.

In some embodiments, a system in accordance with an embodiment can deliver content in a 360-degree format. In this format, a user can view virtual reality content by rotating their phone in space. The video display will change as the phone rotates to illustrate the view in the direction the phone is pointed. This feature can also be used with stereo vision systems. This feature can also be used for augmented reality applications.

FIG. 17A illustrates a user profile interface 1700-a according to an embodiment. Interface 1700-a displays user data 1705 (e.g., name, e-mail address, phone number), a user image 1710, an edit profile 1712 link, total rewards 1715, user rank 1720, rank progress bar 1725, user history 1728 (e.g., average session), referral code 1730, and share link 1735. User rank 1720 may correspond to an amount of interaction with the system. In an embodiment, user rank 1720 may be based on a number of rewards 1715 collected and/or advertisement videos watched. Referral code 1730 may be provided to friends, family, etc., who may activate an account and provide the referral code 1730. When provided, the user may receive rewards (e.g., reward points, tokens, or coins) similar to a reward for watching advertisement videos as discussed above. Share link 1735 may be selected to share referral code 1730 through a variety of channels (e.g., social media, email, text message, other messaging application). In an embodiment, when share link 1735 is selected, a list of sharing options represented by icons 1736-1739 may be displayed as illustrated in FIG. 17B (1700-b). A user may select one or more of icons 1736-1739 to share the referral code 1730 directly through the channel.

When an icon (e.g., 1737) is selected, a posting interface 1740 may be provided (FIG. 17C.) Posting interface 1740 may provide a draft message 1742 (e.g., post) to the corresponding channel 1744 for the user. The use may edit the post (e.g., text or images). Once a user is satisfied, the user may select Post Link 1745 displayed on interface 1740 to instruct the system to automatically format the post according to the selected channel and share the same on the user's account in accordance with the selected channel. The use may select the Cancel link 1748 to cancel the sharing.

FIG. 18 illustrates a chatbot interface 1800 according to an example embodiment. In FIG. 18A, chatbot interface 1800 may be presented upon downloading and/or logging into a streaming application. The chatbot interface 1800 may present dialog from a chatbot 1805 to guide a user log-on 1806 and/or account setup 1808.

FIG. 19A illustrates a chatbot interface 1910 during video streaming. In FIG. 19A, a video 1901 is currently playing. Chatbot interface 1910 overlays a portion of video 1901. Chatbot interface 1910 may present messages 1915 from a chatbot prompting a user for additional information. Messages 1915 may include direct questions (e.g., are you male or female), conversational questions (e.g., I am happy being single. Are you seeing anyone?), or contextual questions (e.g., You seem to watch a lot of a science-fiction shows. Do you generally like science-fiction?). In an embodiment, the type of videos 1901 currently and/or previously watched may determine questions. For instance, a user who watches golf may be asked their favorite player, club, and ball. Potential responses 1920 to the questions may be displayed on chatbot interface 1910. In an embodiment, answering questions may provide the user with additional rewards 1930 (e.g., tokens, reward points, or coins) (FIG. 19B 1900-b), redeemable through a catalog. In an embodiment, chatbot interface 1910 may be initiated after a certain amount of time watching a video 1901, after a certain number of videos 1901 viewed, or periodically over time. In an embodiment, the information gained through chatbot interface 1910 may be used for targeting purposes (e.g., displayed logos or advertisements), to track viewer segments. In an embodiment, an advertiser may utilize the deep data collected via the chatbot interface 1910 to better connect with potential consumers.

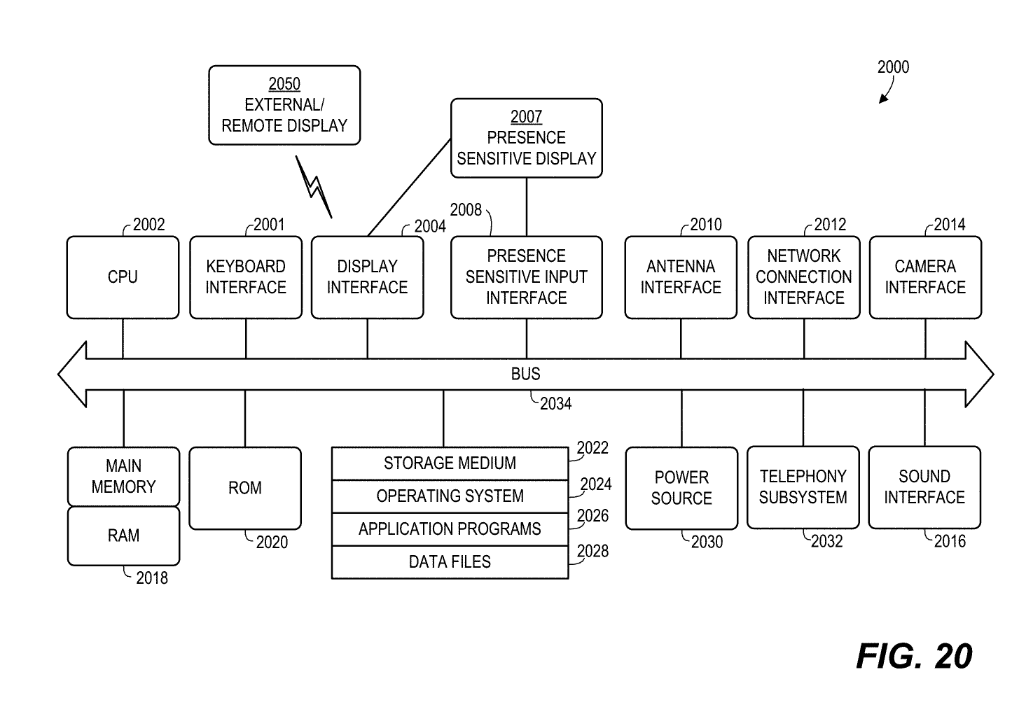

As desired, implementations of the disclosed technology may include a computing device with more or less of the components illustrated in FIG. 20. It will be understood that the computing device architecture 2000 is provided for example purposes only and does not limit the scope of the various implementations of the present disclosed systems, methods, and computer-readable mediums.

The computing device architecture 2000 of FIG. 20 includes a central processing unit (CPU) 2002, where computer instructions are processed; a display interface 2004 that acts as a communication interface and provides functions for rendering video, graphics, images, and texts on the display. In certain example implementations of the disclosed technology, the display interface 2004 may be directly connected to a local display, such as a touch-screen display associated with a mobile computing device. In another example implementation, the display interface 2004 may be configured for providing data, images, and other information for an external/remote display that is not necessarily physically connected to the mobile computing device. For example, a desktop monitor may be utilized for mirroring graphics and other information that is presented on a mobile computing device. In certain example implementations, the display interface 2004 may wirelessly communicate, for example, via a Wi-Fi channel or other available network connection interface 2012 to the external/remote display.

In an example implementation, the network connection interface 2012 may be configured as a communication interface and may provide functions for rendering video, graphics, images, text, other information, or any combination thereof on the display. In one example, a communication interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof. In one example, the display interface 2004 may be operatively coupled to a local display, such as a touch-screen display associated with a mobile device. In another example, the display interface 2004 may be configured to provide video, graphics, images, text, other information, or any combination thereof for an external/remote display that is not necessarily connected to the mobile computing device. In one example, a desktop monitor may be utilized for mirroring or extending graphical information that may be presented on a mobile device. In another example, the display interface 2004 may wirelessly communicate, for example, via the network connection interface 2012 such as a Wi-Fi transceiver to the external/remote display.

The computing device architecture 2000 may include a keyboard interface 2006 that provides a communication interface to a keyboard. In one example implementation, the computing device architecture 2000 may include a presence-sensitive display interface 2008 for connecting to a presence-sensitive display 2007. According to certain example implementations of the disclosed technology, the presence-sensitive display interface 2008 may provide a communication interface to various devices such as a pointing device, a touch screen, a depth camera, etc. which may or may not be associated with a display.

The computing device architecture 2000 may be configured to use an input device via one or more of input/output interfaces (for example, the keyboard interface 2006, the display interface 2004, the presence sensitive display interface 2008, network connection interface 2012, camera interface 2014, sound interface 2016, etc.,) to allow a user to capture information into the computing device architecture 2000. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, the input device may be integrated with the computing device architecture 2000 or may be a separate device. For example, the input device may be an accelerometer, a magnetometer, a digital camera, a microphone, and an optical sensor.

Example implementations of the computing device architecture 2000 may include an antenna interface 2010 that provides a communication interface to an antenna; a network connection interface 2012 that provides a communication interface to a network. As mentioned above, the display interface 2004 may be in communication with the network connection interface 2012, for example, to provide information for display on a remote display that is not directly connected or attached to the system. In certain implementations, a camera interface 2014 is provided that acts as a communication interface and provides functions for capturing digital images from a camera. In certain implementations, a sound interface 2016 is provided as a communication interface for converting sound into electrical signals using a microphone and for converting electrical signals into sound using a speaker. According to example implementations, a random-access memory (RAM) 2018 is provided, where computer instructions and data may be stored in a volatile memory device for processing by the CPU 2002.

According to an example implementation, the computing device architecture 2000 includes a read-only memory (ROM) 2020 where invariant low-level system code or data for basic system functions such as basic input and output (I/O), startup, or reception of keystrokes from a keyboard are stored in a non-volatile memory device. According to an example implementation, the computing device architecture 2000 includes a storage medium 2022 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 2024, application programs 2026 (including, for example, a web browser application, a widget or gadget engine, and or other applications, as necessary) and data files 2028 are stored. According to an example implementation, the computing device architecture 2000 includes a power source 2030 that provides an appropriate alternating current (AC) or direct current (DC) to power components.

According to an example implementation, the computing device architecture 2000 includes a telephony subsystem 2032 that allows the device 2000 to transmit and receive sound over a telephone network. The constituent devices and the CPU 2002 communicate with each other over a bus 2034.

According to an example implementation, the CPU 2002 has appropriate structure to be a computer processor. In one arrangement, the CPU 2002 may include more than one processing unit. The RAM 2018 interfaces with the computer bus 2034 to provide quick RAM storage to the CPU 2002 during the execution of software programs such as the operating system application programs, and device drivers. More specifically, the CPU 2002 loads computer-executable process steps from the storage medium 2022 or other media into a field of the RAM 2018 in order to execute software programs. Data may be stored in the RAM 2018, where the data may be accessed by the computer CPU 2002 during execution. In one example configuration, the device architecture 2000 includes at least 2028 MB of RAM, and 256 MB of flash memory.

The storage medium 2022 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow a computing device to access computer-executable process steps, application programs and the like, stored on removable and non-removable memory media, to off-load data from the device or to upload data onto the device. A computer program product, such as one utilizing a communication system may be tangibly embodied in storage medium 2022, which may comprise a machine-readable storage medium.

According to one example implementation, the term computing device, as used herein, may be a CPU, or conceptualized as a CPU (for example, the CPU 2002 of FIG. 20). In this example implementation, the computing device (CPU) may be coupled, connected, and/or in communication with one or more peripheral devices, such as display. In another example implementation, the term computing device, as used herein, may refer to a mobile computing device such as a smartphone, tablet computer, or smart watch. In this example implementation, the computing device may output content to its local display and/or speaker(s). In another example implementation, the computing device may output content to an external display device (e.g., over Wi-Fi) such as a TV or an external computing system.

In example implementations of the disclosed technology, a computing device may include any number of hardware and/or software applications that are executed to facilitate any of the operations. In example implementations, one or more I/O interfaces may facilitate communication between the computing device and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the computing device. The one or more I/O interfaces may be utilized to receive or collect data and/or user instructions from a wide variety of input devices. Received data may be processed by one or more computer processors as desired in various implementations of the disclosed technology and/or stored in one or more memory devices.

One or more network interfaces may facilitate connection of the computing device inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, etc., for communication with external devices and/or systems.

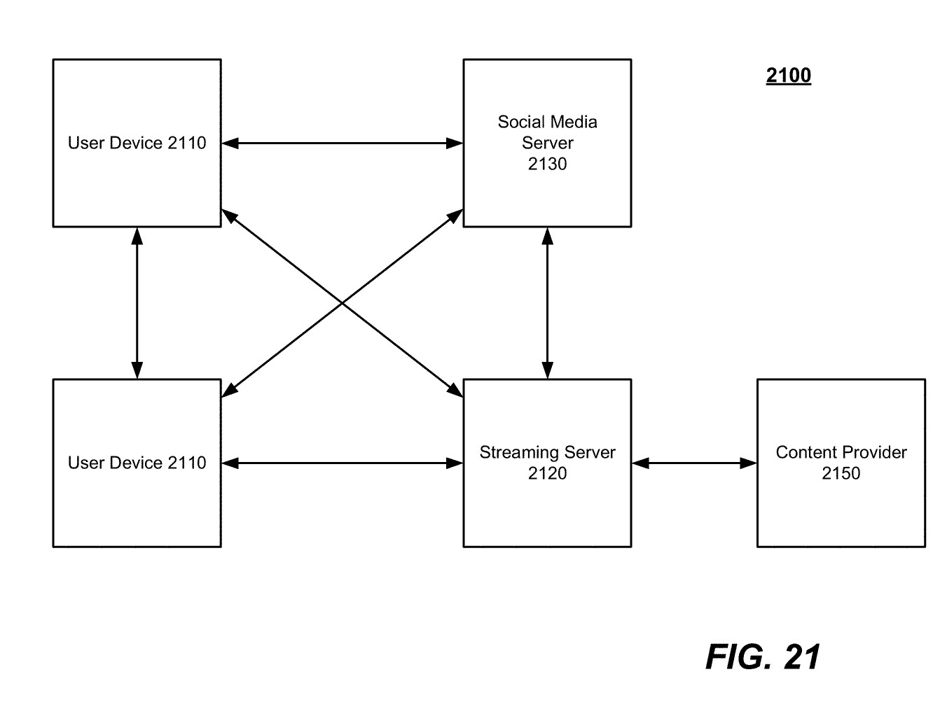

FIG. 21 illustrates an environment 2100 in which one or more aspects of the present disclosure may be implemented. The environment includes one or more user devices 2110, a streaming server 2120, a social media server 2130, and a content provider 2150. One or more aspects of the user devices 2110, streaming server 2120, social media server 2130, and content provider 2150 may be implemented using, as a non-limiting example, the computer architecture described above with reference to FIG. 20. User device 2110 may execute a streaming application supported by streaming server 2120. The streaming application may provide live and/or recorded content to the user devices 2110. The content may be provided by streaming server 2120, which may, in part, gather the content from content provider 2150. User devices 2110 may share the streaming application and/or viewed content view social media. In some cases, streaming server 2120 may generate, format, and/or post messages to the social media server 2130 for a user of the user device 2110. One of ordinary skill will recognize that the user devices 2110, streaming server 2120, social media server 2130, and content provider 2150 may each be implemented using one or more physical or virtual devices. One of ordinary skill, in light of the present disclosure, will recognize that that the user devices 2110, streaming server 2120, social media server 2130, and content provider 2150 are configured to implement various aspects of the present disclosure in accordance with an embodiment.

While the present disclosure has been described in connection with a plurality of exemplary aspects, as illustrated in the various figures and discussed above, it is understood that other similar aspects can be used, or modifications and additions can be made to the described aspects for performing the same function of the present disclosure without deviating therefrom. For example, in various aspects of the disclosure, methods and compositions were described according to aspects of the presently disclosed subject matter. However, other equivalent methods or composition to these described aspects are also contemplated by the teachings herein. Therefore, the present disclosure should not be limited to any single aspect, but rather construed in breadth and scope in accordance with the appended claims.

An embodiment of the present disclosure may be implemented according to the following:

Clause 1: A method comprising: outputting for display, through a streaming application on a user device, a current video; overlaying an interactive link on a portion of the current video; receiving a user selection of the interactive link; and in response to receiving the user selection, deemphasizing the current video and displaying an advertising video corresponding to the selected interactive link.

Clause 2: The method of Clause 1 further including displaying the advertising video in a first interface, the first interface further comprising a rewards counter.

Clause 3: The method of Clause 2, wherein the rewards counter corresponds to a predetermined rewards value for the advertising video and an amount of the advertising video currently viewed through the streaming application.

Clause 4: The method of Clauses 2 or 3 further comprising transitioning a display of the advertising video from the first interface to a second interface, the second interface comprising a substantially full-screen view of the advertising video.

Clause 5: The method of Clause 4, wherein the transitioning is performed after the first interface is displayed a pre-determined about of time.

Clause 6: The method of Clauses 4 or 5 further comprising outputting for display, after completion of the advertising video, a completion interface indicating total rewards received for watching the advertising video.

Clause 7: The method of Clause 6, wherein the completion interface comprises a link to a rewards catalog.

Clause 8: The method of any of Clauses 1-7, wherein deemphasizing the current video comprises pausing the current video.

Clause 9: A method comprising: receiving, from a first user of a streaming application, an indication to share the streaming application; outputting for selection a plurality of sharing channels; receiving an indication of a selection of a first sharing channel of the plurality of sharing channels; automatically formatting a sharing message in accordance with the selected sharing channel, the sharing message comprising an identifier of the first user; and posting an invitation to use the application on the selected sharing channel.

Clause 10: The method of Clause 9 further including receiving, from a device of a second user, a request to access the streaming application, the request including the identifier of the first user; enabling access to the device of the second user; and transferring, to the account of the first user, a predetermined amount of rewards points.

Clause 11: The method of Clause 9 or 10, wherein the selected sharing channel comprises a social media channel, formatting the sharing message comprises incorporating at least one of texts, images and videos as allowed for sharing by the selected social media channel, and posting the invitation comprises accessing a social media account of the first user account based on log-in credentials to the first user account and posting the invitation utilizing an application-programming interface.

Clause 12. The method of any of Clauses 9-11 and any of Clauses 1-8.

Clause 13: A method comprising: outputting for display, over a streaming application and on a user device, a current video; overlaying a chatbot interface over on a portion of the current video; outputting, by a chatbot and through the chatbot interface, a request for user information; and receiving, through the chatbot interface, the user information.

Clause 14: The method of Clause 13 further comprising outputting, within the chatbot interface, a plurality of selectable answers corresponding to the request for user information, wherein receiving the user information comprises receiving an indication of a selection of at least one of the plurality of selectable answers.

Clause 15: The method of Clause 13 or 14, wherein overlaying the chatbot interface is performed at a predetermined interval after a user accesses the streaming application.

Clause 16: The method of any of Clauses 13-15, wherein overlaying the chatbot interface is repeated periodically with requests for different user information.

Clause 17: The method of any of Clauses 13-16, wherein the request for user information comprises a contextual question based on recently viewed content of the user via the streaming application.

Clause 18: The method of any of Clauses 13-17 further comprising transferring, in response to receiving the user information, to an account of the user, a predetermined amount of rewards points.

Clause 19: The method of Clause 18 further comprising: outputting, by the chatbot and through the chatbot interface, an alert of a live auction and a link to the auction; and receiving, through the chat interface, a selection of the link, the rewards point being redeemable through the live auction.

Clause 20: The method of any of Clauses 13-19 further comprising selecting, at least one interactive link to be displayed on the current video based on the received user information.

Clause 21: The method of any of Clauses 13-20 and any of Clauses 1-12.

Clause 22: A method comprising: outputting for display, over a streaming application on a user device, a current video; requesting, via the streaming application, access to a chatroom corresponding to the current video; and overlaying messages of the chatroom over a portion of the current video.

Clause 23: The method of Clause 22, wherein admittance to the chatroom is limited to users of the streaming application currently viewing the current video.

Clause 24: The method of Clause 22, wherein the current video corresponds to a channel, and admittance to the chatroom is limited to users of the streaming application currently viewing a video related to the channel.

Clause 25: The method of Clause 22, wherein the current video is a recorded video, and chatroom participants comprise current viewers of the recorded video and recorded past chat conversations of past viewers of the current video.

Clause 26: The method of Clause 25, wherein the recorded past chat conversations are timestamped to portions in accordance with relative viewing positions of the current video, and the recorded past chat conversations are replayed in accordance with a time state of reviewing the current video on the user device.

Clause 27: The method of any of Clauses 22-26, wherein a chatbot is a participant of the chatroom.

Clause 28: The method of any of Clauses 22-27 and any of Clauses 1-21.

Clause 29: A method of a streaming infrastructure, the method comprising: outputting, to a user device over a streaming application, a current video for display; maintaining a chatroom corresponding to the current video; receiving a request from the user device to access the chatroom; and outputting, over the streaming application, messages of the chatroom to be displayed over a portion of the current video.

Clause 30: The method of Clause 29 further comprising limiting admittance to the chatroom to users of the streaming application currently viewing the current video.

Clause 31: The method of Clause 29, wherein the current video corresponds to a channel, further comprising limiting admittance to users of the streaming application currently viewing a video related to the channel.

Clause 32: The method of Clause 29, wherein the current video is a recorded video, and maintaining the chatroom comprises recording past chat conversations of past viewers of the current video.

Clause 33: The method of Clause 32, wherein recording the past chat conversations comprises timestamping the chat conversations in accordance with relative viewing positions of the current video, and the method further comprises replaying the recorded past conversations via the streaming application based on a viewing position of the current video on by the user device.

Clause 34: The method of any of Clauses 28-33, wherein a chatbot is a participant of the chatroom.

Clause 35: A method comprising: outputting for display, through a streaming application executing on a user device, a current video; receiving, through the user device, a request to share the current video; retrieving, from volatile memory and in response to receiving the request, a previously played portion of the current video; and generating a message sharing the current video and the previously played portion.

Clause 36: The method of Clause 35, wherein the previously played portion of the current video is retrieved from volatile memory of the user device.

Clause 37: The method of Clause 35 or 36, wherein the previously played portion comprises a predetermined period of time prior to receiving the request.

Clause 38: A system comprising: at least one processor; and at least one memory having stored thereon computer program code that, when executed by the at least one processor, controls the processor to execute the method of any of Clauses 1-37.

Clause 39: A non-transitory computer readable medium having stored thereon computer program instructions to execute the method of any of Clauses 1-37.

What is claimed is:

1. A system comprising:
at least one processor; and
at least one memory having stored thereon computer program code that, when executed by the at least one processor, controls the processor to execute a method comprising:
outputting for display, through a streaming application on a user device, a current video;
overlaying an interactive link on a portion of the current video;
receiving a user selection of the interactive link; and
in response to receiving the user selection, deemphasizing the current video and displaying an advertising video corresponding to the selected interactive link.

2. The system of claim 1, wherein the computer program code, when executed by the at least one processor, further controls the processor to output for display the advertising video in a first interface, the first interface further comprising a rewards counter.

3. The system of claim 2, wherein the rewards counter corresponds to a predetermined rewards value for the advertising video and an amount of the advertising video currently viewed through the streaming application.

4. The system of claim 2, wherein the computer program code, when executed by the at least one processor, further controls the processor to transition a display of the advertising video from the first interface to a second interface, the second interface comprising a substantially full-screen view of the advertising video.

5. The system of claim 4, wherein the computer program code, when executed by the at least one processor, further controls the processor to:
transition from the first interface to the second interface after the first interface is displayed a pre-determined about of time; and
output for display, after completion of the advertising video, a completion interface indicating total rewards received for watching the advertising video.

6. A method comprising:
receiving, from a first user of a streaming application, an indication to share the streaming application;
outputting for selection a plurality of sharing channels;
receiving an indication of a selection of a first sharing channel of the plurality of sharing channels;
automatically formatting a sharing message in accordance with the selected sharing channel, the sharing message comprising an identifier of the first user; and
posting an invitation to use the application on the selected sharing channel.

7. The method of claim 6 further comprising receiving, from a device of a second user, a request to access the streaming application, the request including the identifier of the first user;
enabling access to the device of the second user; and
transferring, to the account of the first user, a predetermined amount of rewards points.

8. The method of claim 6, wherein
the selected sharing channel comprises a social media channel,
formatting the sharing message comprises incorporating at least one of texts, images and videos as allowed for sharing by the selected social media channel, and
posting the invitation comprises accessing a social media account of the first user account based on log-in credentials to the first user account and posting the invitation utilizing an application-programming interface.

9. The method of claim 6 further comprising:
retrieving, from volatile memory and in response to receiving the indication to share the streaming application, a previously played portion of a current video if output through the streaming application; and
automatically formatting the sharing message and to include a copy of the previously played portion.

10. The method of claim 9, wherein the previously played portion of the current video is retrieved from volatile memory of a user device executing the streaming application.

11. A non-transitory computer readable medium having stored thereon computer program code that, when executed by at least one processor, controls the at least one processor to execute a method comprising:
outputting for display, over a streaming application and on a user device, a current video;
overlaying a chatbot interface over on a portion of the current video;
outputting, by a chatbot and through the chatbot interface, a request for user information; and
receiving, through the chatbot interface, the user information.

12. The computer readable medium of claim 11, wherein the method further comprises outputting, within the chatbot interface, a plurality of selectable answers corresponding to the request for user information, wherein receiving the user information comprises receiving an indication of a selection of at least one of the plurality of selectable answers.

13. The computer readable medium of claim 11, wherein overlaying the chatbot interface is performed at a predetermined interval after a user accesses the streaming application.

14. The computer readable medium of claim 11, wherein overlaying the chatbot interface is repeated periodically with requests for different user information.

15. The computer readable medium of claim 11, wherein the request for user information comprises a contextual question based on recently viewed content of the user via the streaming application.

16. The computer readable medium of claim 11, wherein the method further comprises transferring, in response to receiving the user information, to an account of the user, a predetermined amount of rewards points.

17. The computer readable medium of claim 11, wherein the method further comprises:
outputting, by the chatbot and through the chatbot interface, an alert of a live auction and a link to the auction; and
receiving, through the chat interface, a selection of the link, the rewards point being redeemable through the live auction.

18. The computer readable medium of claim 11, wherein the method further comprises selecting, at least one interactive link to be displayed on the current video based on the received user information.

19. The computer readable medium of claim 11, wherein the method further comprises:
requesting, via the streaming application, access to a chatroom corresponding to the current video, the chatroom being limited to users of the streaming application currently viewing the current video; and
overlaying messages of the chatroom over a portion of the current video.

20. The computer readable medium of claim 19, wherein
the current video is a recorded video,
chatroom participants comprise current viewers of the recorded video and recorded past chat conversations of past viewers of the current video, and
the recorded past chat conversations are timestamped to portions in accordance with relative viewing positions of the current video, and the recorded past chat conversations are replayed in accordance with a time state of reviewing the current video on the user device.
